(19) United States
(12) Patent Application Publication
(10) Pub. No.: US 2024/0301729 A1
(43) Pub. Date: Sep. 12, 2024

(54) APPARATUS AND METHOD FOR VEHICLE HOOD OPERATION

(71) Applicant: Rajnarine Ramratan, Pickering (CA)

(72) Inventor: Rajnarine Ramratan, Pickering (CA)

(21) Appl. No.: 18/179,322

(22) Filed: Mar. 6, 2023

(51) Int. Cl. E05B 83/24; E05B 81/20

(52) U.S. Cl. CPC E05B 83/24; E05B 81/20

(57) ABSTRACT

An apparatus and method for vehicle hood operation wherein the present invention employs utilization of a key fob and a prescribed method in order to facilitate operation of the hood of the vehicle. The present invention includes a controller that is operably coupled to the power system of the vehicle, the transmission of the vehicle and the mechanical hood release device of the vehicle. The controller is communicably coupled to the key fob. The key fob includes a safety button and a designated button that will provide operation of the hood of the vehicle and move the hood between its closed and open position. The present invention deploys automated lifting members that are operably coupled to the hood of the vehicle and will provide the movement thereof. The safety button must be engaged prior to the hood engagement button for the present invention to provide operation of the hood.

### FIELD OF THE INVENTION

The present invention relates generally to vehicle accessories and features, more specifically but not by way of limitation, an apparatus that is configured to provide automated hood operation of the vehicle wherein the operational interface is provided via a key fob.

### BACKGROUND

Most conventional vehicles include a hood and a trunk providing access to the engine bay and a storage space respectively. Trunk access is typically operated by either a key or an internal release button wherein engagement of the aforementioned transitions the trunk from a closed position to an open position so as to facilitate access to the trunk of the vehicle. It is common for some vehicles to have an additional button on a key fob operably coupled to the vehicle that may provide operation of the trunk wherein a button on the fob is held so as to provide release of the trunk.

While trunk operation is found in existing technology, operation of the hood of a vehicle is still provided in a conventional manner. Most vehicles deploy a spring, latch and cable system wherein the hood release in initiated with a handle disposed in the passenger compartment of the vehicle. The handle is operably coupled to a latch typically via a cable that most often includes an operational spring providing control thereof. A second latch is often present under the hood proximate to the grill of the vehicle that must be engaged to completely remove the hood latch in order to facilitate opening of the hood. Many hoods of vehicles are only hingedly coupled and must be lifted by an individual and then propped open with a bar member. Some hoods are operated by gas struts but the hood must still be manually operated. For most vehicles, operation of the hood opening system is cumbersome and many times locating the hood latch can be difficult.

Accordingly, there is a need for an apparatus and method that can facilitate operation of the hood of the vehicle wherein the hood is moved between its open and closed positions through an automated method employing a key fob as the user interface.

### SUMMARY OF THE INVENTION

It is the object of the present invention to provide an apparatus and method configured to provide operation of the hood of the vehicle and move between its closed and open position wherein the present invention includes a controller having the necessary electronics to receive, transmit, store and manipulate data.

Another object of the present invention is to provide a method and apparatus operable to provide control of a vehicle hood wherein the present invention includes at least one automated lifting member.

A further object of the present invention is to provide an apparatus and method configured to provide operation of the hood of the vehicle and move between its closed and open position wherein the controller of the present invention is operably coupled to the transmission of the vehicle.

Still another object of the present invention is to provide a method and apparatus operable to provide control of a vehicle hood wherein the present invention includes a key fob that is provided as the user interface for the present invention.

An additional object of the present invention is to provide an apparatus and method configured to provide operation of the hood of the vehicle and move between its closed and open position wherein the present invention is operably coupled to a hood release handle disposed within the passenger cabin of the vehicle.

Yet a further object of the present invention is to provide a method and apparatus operable to provide control of a vehicle hood wherein the key fob of the present invention includes a safety button that must be engaged at the beginning of the method of the present invention.

Another object of the present invention is to provide an apparatus and method configured to provide operation of the hood of the vehicle and move between its closed and open position wherein the key fob further includes a hood operation button.

Still another object of the present invention is to provide a method and apparatus operable to provide control of a vehicle hood wherein the hood operation button provides control to move the hood of the vehicle between its closed position and its open position.

An additional object of the present invention is to provide an apparatus and method configured to provide operation of the hood of the vehicle and move between its closed and open position wherein in one embodiment of the method of the present invention the safety button must be engaged more than one time to initiate the method sequence of moving the hood from its closed position to its open position.

Still a further object of the present invention is to provide a method and apparatus operable to provide control of a vehicle hood wherein the safety button on the key fob of the present invention may be a standalone button or a dual function button that is configured to provide an additional operation for the vehicle.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an exemplary vehicle being equipped with the present invention; and

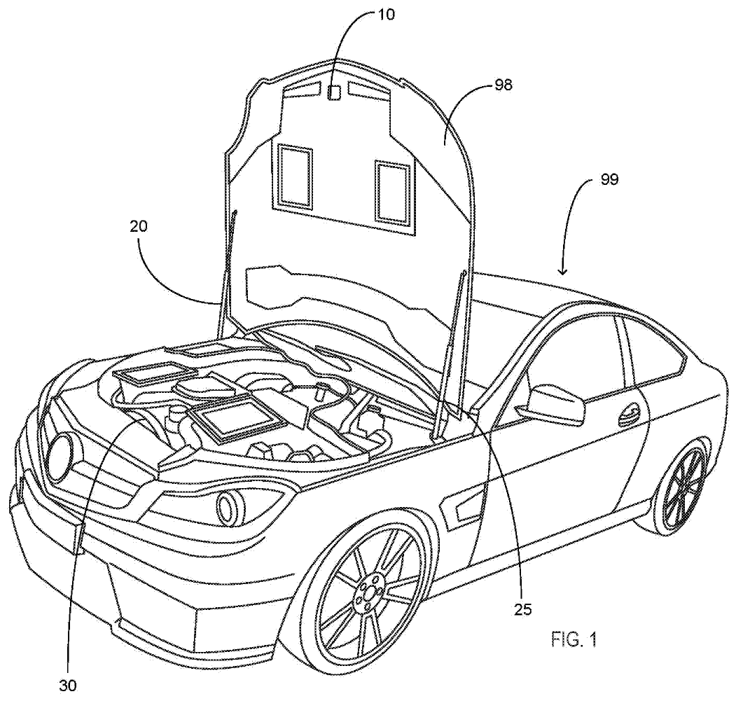

FIG. 2 is a is a perspective view of an exemplary key fob of the present invention; and

FIG. 3 is a diagram of the method of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an apparatus and method for vehicle hood operation 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the apparatus and method for vehicle hood operation 100 includes a controller 10. The controller 10 includes the necessary electronics to receive, store, transmit and manipulate data. The controller 10 provides operation of the method of the present invention as is further discussed herein. While the controller 10 is illustrated herein as being located under the hood of the vehicle 99, it should be understood within the scope of the present invention that the controller 10 could be disposed in alternate locations on the vehicle. The controller 10 is powered by direct current and is operably coupled to the power source of the vehicle 99.

The apparatus and method for vehicle hood operation 100 includes automated lifting members 20,25. The automated lifting members 20,25 are configured to move the hood 98 intermediate a closed and an open position. The lifting members 20,25 are operably coupled to the controller 10 and upon receipt of a signal transmitted by the controller 10, the lifting members 20, 25 execute either opening or closing of the hood 98. The lifting members 20,25 in a preferred embodiment are electric struts but it should be understood within the scope of the present invention that the lifting members 20,25 could be manufactured from alternate technologies such as but not limited to powered gas struts. While two lifting members 20,25 are illustrated herein, it is contemplated within the scope of the present invention that one lifting member could be employed to execute the objective of moving the hood 98 between an open and a closed position.

The controller 10 is operably coupled to the transmission (not particularly illustrated herein) of the vehicle 99. In order to execute the method of the present invention, the controller 10 is communicably coupled to the transmission of the vehicle 99 so as to ascertain the gear in which the vehicle 99 is in. As is further discussed herein, the operation of the apparatus and method for vehicle hood operation 100 requires identification and verification that the vehicle transmission is in a park only mode. The controller 10 is further operably coupled to the hood release 30 of the vehicle 99. The hood release 30 is a conventional mechanical coupling that provides maintaining of the hood 98 in a closed position until released, most commonly by a mechanical lever located in the passenger cabin of the vehicle 99. The controller 10 of the present invention is operably coupled to the hood release 30 so as to provide release thereof in order to move the hood 98 from a closed position to an open position. It is contemplated within the scope of the present invention that the controller 10 could be operably coupled to the hood release 30 employing alternate techniques in order to achieve the objective of moving the hood 98 from a closed position to an open position.

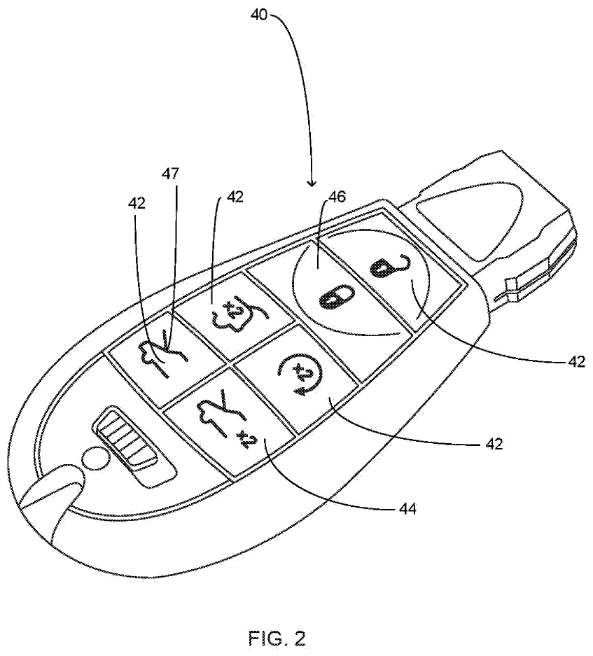

Illustrated herein in FIG. 2 is the key fob 40 of the present invention. The key fob 40 includes the necessary electronics to receive, store, transmit and manipulate data. The key fob 40 is communicably coupled to the controller 10 utilizing suitable wireless communication protocols. The key fob 40 includes conventional engagement buttons 42 that provide common features such as but not limited to locking doors, unlocking doors, releasing a trunk, panic alarm and remote start. The key fob 40 includes engagement button 44 and safety button 46. Engagement button 44 is configured to provide operation of the hood 98 of the vehicle 99 wherein proper engagement thereof will move the hood 98 between a closed position and an open position. The engagement button 44 is operably dependent on safety button 46 and will not function unless prescribed utilization of the safety button 46 has occurred. In a preferred embodiment of the present invention, the safety button 46 must be depressed two times in order for the engagement button 44 to function so as to provide operation of the hood 98 of the vehicle 99. Additionally, as is described in the method herein, the engagement button 44 must be depressed more than one time in order to execute the function of hood operation. Button 47 functions in a similar capacity and is employed to closed the hood of the vehicle 99. While a particular safety button 46 has been illustrated herein, it is contemplated within the scope of the present invention that the safety button 46 could be embodied in alternate manners and achieve the desired objective of requiring engagement thereof prior to the engagement button 44 so as to execute the hood operation. Furthermore, it is contemplated within the scope of the present invention that the hood 98 could have a switch or button located on the underside thereof that would be operable to provide closure of the hood 98.

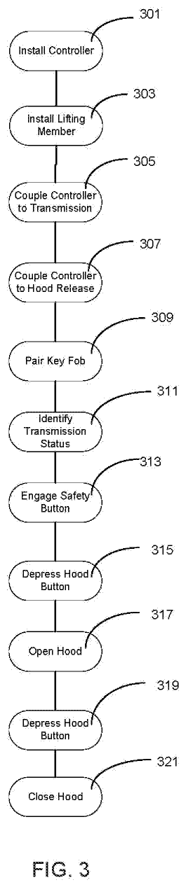

Now referring to FIG. 3 herein, the method of the present invention is diagrammed therein. In step 301, the controller 10 is installed into the vehicle 99 in a desired location utilizing suitable techniques. Step 303, the lifting members 20,25 are operably coupled to the hood 98 of the vehicle 99. In step 305, the controller 10 is operably coupled to the transmission of the vehicle 99 and provides monitoring of the status thereof so as to determine the gear in which the transmission is in at all times. Step 307, the controller 10 is operably coupled to the hood release mechanism of the vehicle 99. In step 309, the key fob 40 is communicably paired with the controller 10 utilizing suitable wireless communication protocols. Step 311, the controller 10 continually identifies the status of the transmission. The present invention is only operational upon detection of the transmission being in park status wherein the park status must have been detected for at least ten seconds in order to inhibit accidental opening of the hood 98. In step 313, the user will engage the safety button 46 and move the safety button 46 from its first position to its second position wherein the user will slide the safety button 46 to accomplish the aforementioned. It is contemplated within the scope of the present invention that the safety button 46 could be provided in alternate configurations. By way of example but not limitation, the safety button 46 could be configured as a button that is to be depressed by a user wherein the safety button of this configuration would require to be depressed at least twice by a user in order to activate the ability to open the hood 98 of the vehicle 99.

Step 315, subsequent prescribed engagement of the safety button 46, the user will depress button 44 wherein in a preferred embodiment of the present invention, the user will depress the button 44 at least twice. In step 317, the hood 98 of the vehicle 99 will be opened by the lifting members 20,25. Step 319, ensuing completion of a desired activity within the engine bay of the vehicle 99, the user will depress button 44 at least twice. In step 321, the hood 98 will be moved to its closed position.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method of controlling operation of a hood of a vehicle wherein the method comprises:
installing a controller, said controller having electronics to transmit, receive, store and manipulate data;
installing at least one lifting member, said at least one lifting member being operably coupled to the hood of the vehicle, said at least one lifting member being operably coupled to said controller, said at least one lifting member configured to move the hood between a closed and an open position;
coupling the controller to a hood release device, wherein the controller is operably coupled to the hood release device of the vehicle;
pairing a key fob to the controller, wherein the key fob is operationally paired to the controller utilizing suitable wireless communication protocols;
engaging a safety button on the key fob, wherein the safety button on the key fob must be initially engaged in order to facilitate operation of the hood of the vehicle;
depressing a hood release button, wherein ensuing engagement of the safety button the hood release button is operably engaged;
opening the hood, wherein subsequent depression of the hood release button the hood is moved from a closed position to an open position;
engaging the hood release button, wherein a user engages the hood release button during the hood being in an open position; and
closing the hood, wherein the at least one lifting member closes the hood ensuing engagement of the hood release button.

2. The method of controlling operation of the hood of the vehicle as recited in claim 1, and further including a step of operably coupling the controller to a transmission of the vehicle.

3. The method of controlling operation of the hood of the vehicle as recited in claim 2, and further including a step of monitoring a status of the transmission of the vehicle, wherein the status of the transmission is continuously monitored by the controller.

4. The method of controlling operation of the hood of the vehicle as recited in claim 3, and further including a step of identifying the status of the transmission, wherein the status of the transmission is identified as being in park for at least ten seconds.

5. The method of controlling operation of the hood of the vehicle as recited in claim 4, wherein the safety button is moved from a first position to a second position in order to permit opening sequence of the hood of the vehicle.

6. The method of controlling operation of the hood of the vehicle as recited in claim 5, wherein the hood release button is engaged at least twice in order to facilitate movement of the hood from a closed position to an open position.
